(19) United States
(12) Patent Application Publication
(10) Pub. No.: US 2015/0317656 A1
(43) Pub. Date: Nov. 5, 2015

(54) Systems and Methods for Aggregation of Online Advocacy Activity Data Based Upon Electoral District

(71) Applicant: Rebuilding Alliance, San Mateo, CA (US)

(72) Inventor: Donna Baranski-Walker, San Mateo, CA (US)

(73) Assignee: Rebuilding Alliance

(21) Appl. No.: 14/703,541

(22) Filed: May 4, 2015

Related U.S. Application Data
(60) Provisional application No. 61/987,765, filed on May 2, 2014.

(51) Int. Cl. G06Q 30/02; G06Q 50/00; G06Q 50/26

(52) U.S. Cl. CPC G06Q 30/0205; G06Q 50/26; G06Q 50/01

(57) ABSTRACT

Systems and methods for aggregating online advocacy activities based upon electoral district are described that can display information derived from aggregated advocacy activities via an interactive map. Online advocacy activities can also include the reporting of advocacy activities that were not conducted online. The availability of online data describing advocacy activities conducted both online and offline enables the mapping of the aggregated advocacy activities. In many embodiments, advocacy activities performed online via one or more social media services are automatically aggregated by an aggregation server based upon congressional district. Online advocacy activity can be aggregated across multiple social media services and several embodiments of the invention enable communication with identified constituents to further coordinate and/or respond to online advocacy activities. In a number of embodiments, a mobile software application can be utilized to enable online advocacy activity, report of online advocacy, and/or conduct crowd fundraising.

### CROSS-REFERENCE TO RELATED APPLICATIONS

The present invention claims priority under 35 U.S.C. §119(e) to U.S. Provisional Patent Application Ser. No. 61/987,765 entitled “Systems and Methods for Aggregation of Online Advocacy Activity Data Based upon Electoral District” filed May 2, 2014. The disclosure of U.S. Provisional Patent Application Ser. No. 61/987,765 is hereby incorporated by reference in its entirety.

### BACKGROUND

Lobbying is the act of attempting to influence legislation, regulations, appointments, decisions, or any other program, or policy of a government or elected official. Lobbying is done by many different types of people and organized groups, including individuals in the private sector, corporations, fellow legislators or government officials, or advocacy groups. While lobbyists are ideally among a legislator's constituencies, meaning a voter within an elected official's electoral district, many lobbyists conduct lobbying activities as a business on behalf of interests that may not be geographically located within an elected official's electoral district.

As was reported by David Carr in the New York Times (http://www.nytimes.com/2008/11/10/business/media/10carr.html?_r=0), the 2008 presidential election saw the emergence of social media as a lower cost tool for communicating with supporters than traditional voter lists, phone banks and direct mail. Use of social media was credited with helping “raise a record-breaking $600 million, and created all manner of media clips that were viewed millions of times. It was an online movement that begot offline behavior, including producing youth voter turnout that may have supplied the margin of victory”. In addition, “instead of constant polling that has been a motor of presidential governance, . . . [the] White House can use the Web to measure voter attitudes”.

The use of social media to reach, influence, and ask for the support of elected officials is also well documented. Social media services such as the Twitter service provided by Twitter, Inc. of San Francisco, Calif. and the Facebook service provided by Facebook, Inc. of Menlo Park, Calif. provide a public forum for communication between members of congress and members of the public. A paper entitled “How Constituents Lobby Members of Congress on Twitter” by Andrew Roback and Libby Hemphill of the Illinois Institute of Technology that was delivered at the 2013 Annual Meeting of the American Political Science Association (Aug. 29-Sep. 1, 2013), notes that in 2012 every member of congress elected to the 113^{th} Congress had a Twitter account run by their campaign office, or by the member of congress him or herself. The paper further notes that much of the literature studying the use of social media in the political process has focused on the use of social media services such as Twitter by elected officials to broadcast messages to constituents and that comparatively little is known about how constituents use social media to lobby members of congress. Studies presented in the paper by Roback and Hemphill suggest that “constituents engage in . . . sophisticated forms of lobbying” via Twitter (Id. p. 3).

### SUMMARY OF THE INVENTION

Systems and methods in accordance with embodiments of the invention aggregate online advocacy activities based upon electoral district and can display information derived from aggregated advocacy activities via an interactive map. Advocacy activities can include (but are not limited to) seeking to reach, influence and obtain support from elected officials and may take a variety of forms including educational activities, coaching others to become more effective advocates, connecting advocates for a cause, fundraising activities, and/or voter registration activities. Online advocacy activities can include advocacy activities conducted online such as (but not limited to) the use of social media to reach, influence and seek support from elected officials. Online advocacy activities can, however, also include advocacy activities conducted offline for which data describing the advocacy activities is available online. For example, online advocacy activities can include information about a class conducted in person or a fundraising event. Online advocacy activities can also include the reporting of advocacy activities that were not conducted online (i.e. offline advocacy activities) such as, but not limited to, reporting the placement of a candle in a window in support of a cause. The availability of online data describing advocacy activities conducted both online and offline enables the mapping of the aggregated advocacy activities in accordance with many embodiments of the invention.

Geosocial networking is a type of social networking in which geographical information such as geocoding and geotagging are used to associate activity within an online social network with real world geographic locations. Geographic information within a geosocial network can be obtained based upon user-submitted location data, IP addresses, hotspot trilateration, cell tower localization, and/or GPS data captured by a computing device being used to engage with a social network. Systems and methods in accordance with many embodiments of the invention can utilize geographic information to aggregate social media activities related to advocacy activities around elected official's electoral districts. In this way, an elected official can filter social activity to identify advocacy efforts undertaken by voters within her or his electoral district. In several embodiments, information summarizing online advocacy activity aggregated across one or more social media services based upon electoral district is displayed on an interactive map. The online advocacy activity can be filtered based upon type of activity, source of information about the activity, issue, and expressed sentiment.

One embodiment of the invention includes an aggregation server system, comprising:

a processor; memory containing: electoral district data, where the electoral district data describes the geographic boundaries of a plurality of electoral districts; and an aggregation server application. In addition, the aggregation server application configures the processor to: retrieve online advocacy activity data and store the online advocacy activity data within an advocacy activity database, where the online advocacy activity data describes a plurality of instances of advocacy activity; associate at least one electoral district with the online advocacy activity data describing each of the plurality of instances of advocacy activity; and generate an interactive map of advocacy activity occurring within the plurality of electoral districts.

In a further embodiment, the aggregation server application configures the processor to retrieve online advocacy activity data from a remote server system that gathers reports of online advocacy activities.

In another embodiment, the remote server system is part of a social media service.

In a still further embodiment, the aggregation server application further configures the processor to: retrieve data describing social media activities from the remote server system, which is part of a social media service; and classify individual social media activities described in the retrieved data to identify online advocacy activities.

In still another embodiment, the aggregation server application further configures the processor to score individual social media activities described in the retrieved online advocacy activity data and classified as online advocacy activities with respect to sentiment.

In a yet further embodiment, the aggregation server application further configures the processor to: retrieve data describing social media activities from the remote server system that is part of a social media service, where the retrieved data contains uniquely identifying information for at least one user of the social media service; and retrieve data describing a residential address for each of the at least one user of the social media service identified by the uniquely identifying information from a remote server system that is part of a customer insight service.

In yet another embodiment, the online advocacy data is retrieved from the remote server system in batch form.

In a further embodiment again, the aggregation server application further configures the processor to receive reports containing online advocacy activity data over a network interface, where the reports are provided via a web interface.

In another embodiment again, the aggregation server application further configures the processor to receive reports containing online advocacy activity data over a network interface, where the reports are provided via a user device configured with a mobile software application.

In a further additional embodiment, the aggregation server system is connected to a network and the system further includes: a plurality of user devices, where each user device comprises: a processor; and memory containing a mobile software application. In addition, the mobile software application configures the processor to: receive user input describing advocacy activity via a user interface; generate a report containing online advocacy activity data describing the advocacy activity described in the user input; and transmit the report to the aggregation server system.

In another additional embodiment, the mobile software application further configures the processor of a user device to: receive a user input pledging to donate funds to a specific cause via a user interface; generate a report containing online advocacy activity data describing the pledge to donate funds to the specific cause; and the aggregation server application further configures the processor to: receive a report containing online advocacy activity data describing a pledge of a specific user to donate funds to a specific cause; update a total pledged amount associated with the specific cause in the advocacy activity database; and initiate at least one funds transfer based upon at lease one user pledge utilizing a transaction processing server system.

In a still yet further embodiment, the mobile software application further configures the processor of a user device to: display user identifiers of a plurality of users of the system; and initiate communication with at least one of the plurality of users of the system in response to a user instruction received via a user interface.

In still yet another embodiment, the mobile software application further configures the processor of a user device to initiate communication using at least one communication technique selected from the group consisting of initiating a telephone call, initiating a video call, joining a conference call, sending a text message, and sending an electronic mail message.

In a still further embodiment again, the aggregation server application further configures the processor to associate at least one electoral district with the online advocacy activity data describing each of the plurality of instances of advocacy activity by: associating online advocacy activity data with at least one user account maintained within the advocacy activity database, where a residential address is associated with each of the at least one user account maintained within the advocacy activity database; and mapping online advocacy activity data to at least one electoral district based upon a residential address of a user account with which the online advocacy activity data is associated.

In still another embodiment again, the aggregation server application further configures the processor to generate an interactive map of advocacy activity occurring within the plurality of electoral districts by querying the advocacy activity database to aggregate advocacy activity based upon individual electoral districts.

In a still further additional embodiment, the aggregation server application further configures the processor to generate an interactive map of advocacy activity occurring within the plurality of electoral districts by: generating a layer of mapping data; and providing the layer of mapping data to a remote server system of a mapping service.

In still another additional embodiment, the aggregation server application further configures the processor to provide the interactive map to a user device; and the interactive map enables the filtering of online advocacy activities based upon at least one of source of online advocacy activity data and type of advocacy activity using the user device.

In a yet further embodiment again, the aggregation server application further configures the processor to verify the online advocacy activity data by verifying that a residential address associated with the online advocacy activity data is located within an electoral district in which the advocacy activity occurred.

In yet another embodiment again, the aggregation server application further configures the processor to verify the online advocacy activity data by verifying that a registered voter with identifying information corresponding to identifying information associated with the online advocacy activity data is registered to vote at a residential address associated with the online advocacy activity data.

In a yet further additional embodiment, the aggregation server application configures the processor to generate the interactive map of advocacy activity occurring within the plurality of electoral districts containing information at a level of detail determined based upon access permissions of a user requesting the interactive map.

In yet another additional embodiment, the interactive map obfuscates residential addresses associated with online advocacy activity data associated with the residential addresses.

### BRIEF DESCRIPTION OF THE DRAWINGS

FIG. 1 is a network diagram illustrating a system for aggregating online advocacy activity based upon electoral district in accordance with an embodiment of the invention.

FIG. 2 conceptually illustrates an aggregation server system in accordance with an embodiment of the invention.

FIG. 3 is a flow chart illustrating a process for aggregating online advocacy activity based upon electoral district in accordance with an embodiment of the invention.

FIG. 4 is a flow chart illustrating a process for aggregating online advocacy activity data based upon social media activity data in accordance with an embodiment of the invention.

### DETAILED DESCRIPTION OF THE DRAWINGS

Turning now to the drawings, systems and methods for the aggregation of online advocacy activities based upon electoral district are illustrated. In many embodiments, advocacy activities are reported to an aggregation server, which aggregates the advocacy activity based upon electoral district. The aggregated activities can then be utilized to generate interactive maps that both enable elected officials and the public (including the constituents themselves) to determine the number of constituents within their electoral districts that are engaged with a specific issue and/or their sentiment, and allow for discussion among constituents, and with the staff of the elected officials.

In many embodiments, advocacy activities performed online via one or more social media services are aggregated by an aggregation server based upon congressional district. In this way, advocacy activities need not be directly reported by users to an aggregation server. Instead, online advocacy activities conducted via social media services can be retrieved by the aggregation server, classified based upon relevancy to a particular issue and/or scored with respect to characteristics such as (but not limited to) sentiment and/or lobbying strategy. Online advocacy activity can be aggregated across multiple social media services and many embodiments of the invention enable communication with identified constituents to further coordinate and/or respond to online advocacy activities.

In a number of embodiments, a mobile software application can be utilized to enable online advocacy activity and/or the reporting of online advocacy activity using any of a variety of mobile devices. In certain embodiments, the mobile software application can be utilized to access interactive maps. In many embodiments, the mobile software application can be utilized as a crowd funding portal via which solicitations for funds can be made. As readily can be appreciated, the donation of funds via the mobile software application is itself a form of online advocacy activity that can then be aggregated and visualized using interactive maps in accordance with various embodiments of the invention. In further embodiments, mobile software applications can be utilized to provide images such as (but not limited to) wallpapers on the lock screen and/or home screen of the mobile device to provide a powerful visual tool in support of a cause (e.g. a virtual flickering candle or advocacy message). In this way, the mobile device itself when not otherwise in use can become an advocacy tool.

In several embodiments, donors (contributing to whatever project is important to them) can be enrolled into the advocacy system so that they can participate in policy discussions, ask for help and advocate for solutions regarding their donation or cause.

In many embodiments, information concerning voter registration and unregistered voters can be displayed via interactive maps using the system and the system can aggregate voter registration service-providers.

To more accurately reflect constituent interest in an issue, a mass movement may want to integrate constituent counts from co-sponsoring groups (e.g., places of worship, local branches of national organizations, etc.). Because of the sensitive and proprietary nature of mailing lists, systems in accordance with various embodiments of the invention can include a standalone batch utility that sister groups can run that takes a mailing list and, based upon address-city-zip code information, determines the corresponding congressional district. In certain embodiments, the batch utility produces three files: the original contents with congressional district information, a file containing an anonymized (and non-invertible) location and congressional district list, and a congressional district count summary. The last two files can be safely given to the issue organizer.

Systems and methods for the aggregation of online advocacy activities based upon electoral district in accordance with embodiments of the invention are discussed further below.

### Systems for Aggregation of Online Advocacy Activities Based Upon Electoral District

Aggregation of online advocacy activities based upon electoral district involves obtaining data concerning online advocacy activities and associating a real world geographic location with each online advocacy activity. In many embodiments, an aggregation server system is utilized to build an advocacy activity database containing data describing online advocacy activities and geographic locations associated with the advocacy activities. The database can then be utilized to create aggregations based upon electoral districts. These aggregations can then form the basis of interactive maps. In several embodiments, the electoral district boundaries and/or the aggregated data are provided as one or more layers to a mapping server and the mapping server renders an interactive map, which enables interactive exploration of the online advocacy activities within a given electoral district. For example, a user can view the sum of the number of registrants and/or participants within individual congressional districts and/or sums with respect to specific types of online advocacy activity. In other embodiments, the aggregation server system itself can generate interactive maps.

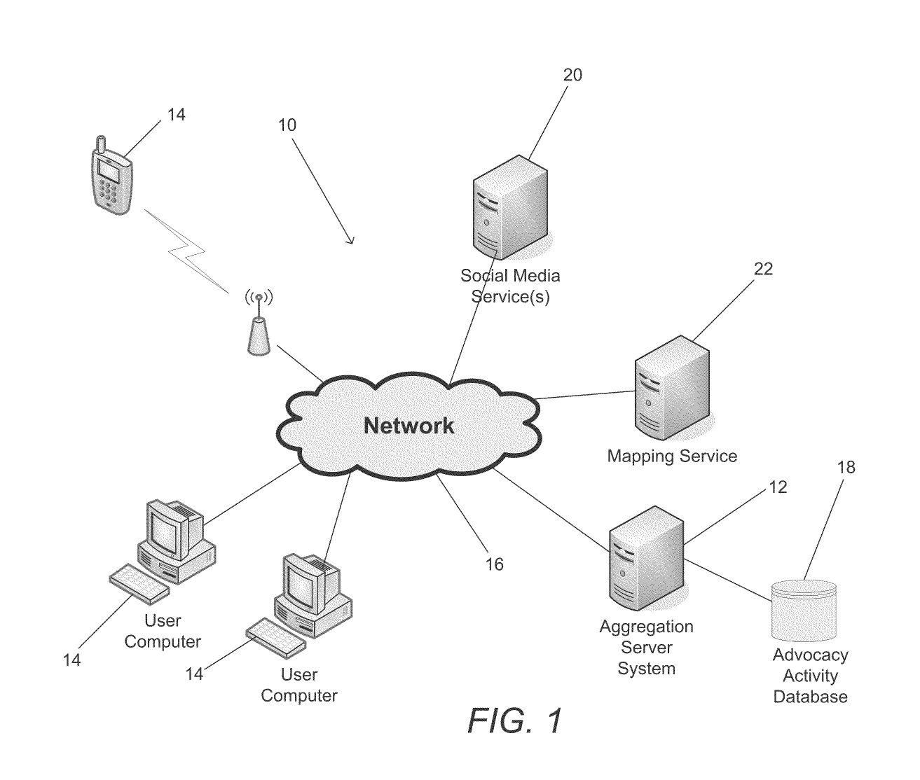

A system for online aggregation of advocacy activities based upon electoral district in accordance with an embodiment of the invention is illustrated in FIG. 1. The system 10 includes an aggregation server system 12 that collects online advocacy activity data from user devices 14 via a network 16 such as (but not limited to) the Internet. The online advocacy activity data is stored in an advocacy activity database 16. As is discussed further below, user online advocacy data can also be collected indirectly from other sources. In certain embodiments, remote servers in third party systems gather reports of online advocacy activities and provide the reports in a batch form as a flat file and/or enable the aggregation server system 12 to access the stored reports via an Application Programming Interface (API). In a number of embodiments, user online advocacy activity data is obtained indirectly via social media services 18.

In the illustrated embodiment, the aggregation server is configured to retrieve social media activity data from social media services 18 using techniques including (but not limited to) requesting data via APIs from one or more social media service server systems and/or requesting data from a service that itself aggregates social media activity data retrieved from one or more social media services. The retrieved social media activity data can be pre-filtered by the social media service server systems to only provide data concerning social media activities that are online advocacy activities. Alternatively, the aggregation server can retrieve social media activity data and classify social media activities to identify social media activity data that describes online advocacy activities. In many embodiments, APIs of social media services provide uniquely identifying information that can be utilized to obtain residential address information for a specific user of a social media service. In several embodiments, remote servers of a customer insight service can be queried to obtain residential address information for a uniquely identified user of a social media service. In several embodiments, natural language processing is utilized to score the relevancy of text strings such as (but not limited to) status updates, and short messages to specific topics and/or categories of online advocacy activities. In a number of embodiments, the aggregation server also scores social media activity data determined to describe online advocacy activities with respect to other classifications including (but not limited to) sentiment and/or lobbying strategy. In this way, an aggregation server system in accordance with several embodiments of the invention can automatically aggregate data concerning online advocacy activities conducted via third party platforms such as (but not limited to) online social networks.

In several embodiments, the aggregation server system maintains geographic location information with respect to users that maintain accounts with the aggregation server system and/or that have identified accounts with which they are associated on social media services. The geographic location information can take the form of a residential address that can then be mapped to specific electoral districts. In many embodiments, the aggregation server system is also able to retrieve geographic location information concerning online advocacy activities identified within social media activity data via APIs provided by social media services that provide geographic information. As many social media services prohibit the caching or aggregation of geographic location information obtained via the API of the service, aggregation server systems in accordance with many embodiments of the invention can perform a real time mapping of the geographic location to one or more relevant electoral districts and store the electoral district information. In this way, the geographic location information is not stored within the advocacy activity database. Where storage of geographic location information is permitted, the geographic location can be stored and/or the electoral district information can be stored. As can readily be appreciated, a single online advocacy activity may map to different electoral districts at the municipal, county, state, and federal level. Therefore, a single online advocacy activity may be associated with multiple electoral districts within the advocacy activity database.

Associations between online advocacy activities and electoral districts described within the advocacy activity database can be utilized to generate maps that aggregate online advocacy activities. In many embodiments, aggregations of online advocacy activities and number of constituents based upon electoral district can be used to generate a layer of mapping data that can be provided to a remote server system of a mapping service 22. The mapping service can then use the layer to generate an interactive map showing relevant electoral districts and the aggregated online advocacy activity. In many embodiments, the mapping service generates an interactive map enabling the filtering of online advocacy activities by electoral district(s) based upon criteria including (but not limited to) source of online advocacy activity (e.g. direct reports of online advocacy activities, petitions, letters and/or social media service used to conduct online advocacy activity), issue, and/or sentiment. In this way, elected officials can gauge the support of individual constituents within their electoral districts with respect to a specific issue. In many embodiments, the aggregation server system generates a layer of data that enables a user to drill down to the level of individual online advocacy activities and links back to the online advocacy activity. Where the online advocacy activity is conducted via a social media service and/or reported via a user account registered with the aggregation server system, the layer of aggregated online advocacy activity data provided to the mapping service by the aggregation server system can enable the user to link to specific activities on social media services. In this way, an organization attempting to coordinate online advocacy activities, an elected official, and/or a candidate for public office can directly communicate with voters within an electoral district that have conducted online advocacy activities with respect to a particular issue (even where the individual conducting the online advocacy activity is not a registered user with the aggregation server system). Although a mapping service is utilized in the illustrated embodiment, aggregation server systems in accordance with many embodiments can incorporate mapping servers that enable the aggregation server system to both aggregate data concerning online advocacy activities and to generate interactive maps.

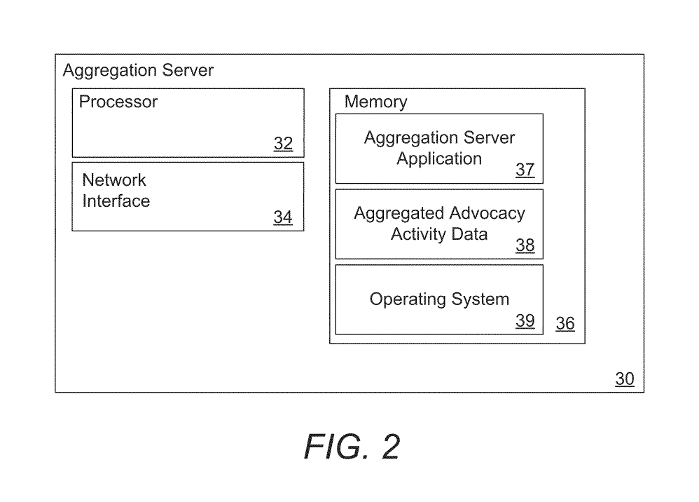

An aggregation server that can be utilized within an aggregation server system in accordance with an embodiment of the invention is illustrated in FIG. 2. The aggregation server 30 is a computing device including a processer 32, a network interface 34, and memory 36. In the illustrated embodiment, the memory 36 contains an aggregation server application 37, aggregated online advocacy activity data 38, and an operating system 39. As described above, the aggregation server application 37 configures the processor 32 to aggregate data concerning online advocacy activities within an advocacy activity database. The online advocacy activity data can be directly reported to the advocacy server 30 via a web interface and/or client applications maintained on user computing devices that communicate with the aggregation server via an interface such as (but not limited to) an API. In many embodiments, the aggregation server 30 retrieves data describing activities on social media services using the network interface 34. The aggregation server application 37 can also configure the processor to query an advocacy activity database to create aggregations of advocacy activity data based upon electoral district. The aggregations can then be formatted into one or more layers (or other appropriate data structure) that can be utilized in the generation of one or more interactive maps.

As noted above, in many embodiments of the invention users directly report online advocacy activity to an aggregation server system. Accordingly, aggregation servers in accordance with several embodiments of the invention are implemented by adapting the Ushahidi platform to implement the various methods described herein. Ushahidi is open source software developed by Ushahidi, Inc., which is a non-profit software company that develops software for information collection, visualization, and interactive mapping. Ushahidi enables local observers to submit reports via the Internet to create a temporal and geospatial archive of events. In many embodiments, the Ushahidi platform is modified to enable an aggregation server to receive reports of online advocacy activities. The aggregation server can then utilize information concerning electoral districts to generate interactive maps in which reports concerning online advocacy activities are aggregated based upon electoral district. As can be readily appreciated, direct reporting of online advocacy activities is potentially the simplest deployment of an aggregation server system in accordance with embodiments of the invention. Users register user accounts (enabling simple user activity verification) and can provide geographic location information (e.g. residential addresses, places of worship, and/or places of business). Furthermore, reports submitted via the Ushahidi platform used to implement the aggregation server system are known to contain data concerning online advocacy activities. Therefore, the report data submitted by users can be structured in a manner that incorporates useful additional metadata including (but not limited to) categorization and sentiment metadata. Reports can also include additional metadata describing online advocacy activities conducted via a mobile software application utilized to submit the report including (but not limited to) communications with other users facilitated by the software application.

Aggregation server systems in accordance with embodiments of the invention are by no means limited to aggregating online activity data from user generated reports provided directly to the aggregation server system. Online advocacy activity data can be aggregated from multiple sources in addition to or as an alternative to direct user reports of online advocacy activities including (but not limited to) retrieving social media activity data that contains data describing online advocacy activities, and/or feeds, flat files and/or databases of online activity data aggregated by other systems. As noted above, a number of systems in accordance with embodiments of the invention aggregate online advocacy activity data by obtaining data concerning activity on social media services. In certain embodiments, aggregation servers utilize services such as (but not limited to) the Radian6 service provided by Salesforce.com, Inc. of San Francisco, Calif. to obtain social media activity data. Radian6 provides a Representational State Transfer RESTful XML web service that can be used for retrieving, analyzing, and exporting social post data for use by an aggregation server system in accordance with an embodiment of the invention. An aggregation server can utilize the Radian6 service to monitor for social media activity constituting online advocacy activities. Such activity can be identified using techniques including (but not limited to) providing a list of keywords and/or hashtags that are likely to be utilized in social media posts that are online advocacy activities. The social media activity data identified by services such as (but not limited to) the Radian6 service can be imported by the aggregation server and (optionally) processed using natural language processing techniques to further score and/or classify the social media activity data. The retrieved social media data can then be processed to generate online advocacy activity data that can be saved into an advocacy activity database and associated with the relevant electoral districts based upon a verified user account associated with the social media activity and/or geospatial data retrieved as part of the social media activity data.

In addition, the aggregation server can facilitate communication between users. In several embodiments, mobile software applications installed on user devices can initiate communication between users using techniques including (but not limited to) initiating a telephone call, initiating a video call, joining a conference call, sending a text message, and sending an electronic mail message. In this way, systems for aggregating online advocacy activity can also provide tools for conducting additional advocacy activities.

Although specific implementations of aggregation server systems in accordance with embodiments of the invention are described above with reference to FIGS. 1 and 2. Any of a variety of technologies can be utilized to aggregate data concerning online advocacy activity, map the activity to electoral districts and display the aggregated data via interactive maps in accordance with embodiments of the invention. Processes for aggregating online advocacy activity based upon electoral district in accordance with embodiments of the invention are discussed further below.

### Processes for Aggregating Online Advocacy Activity Based on Electoral District

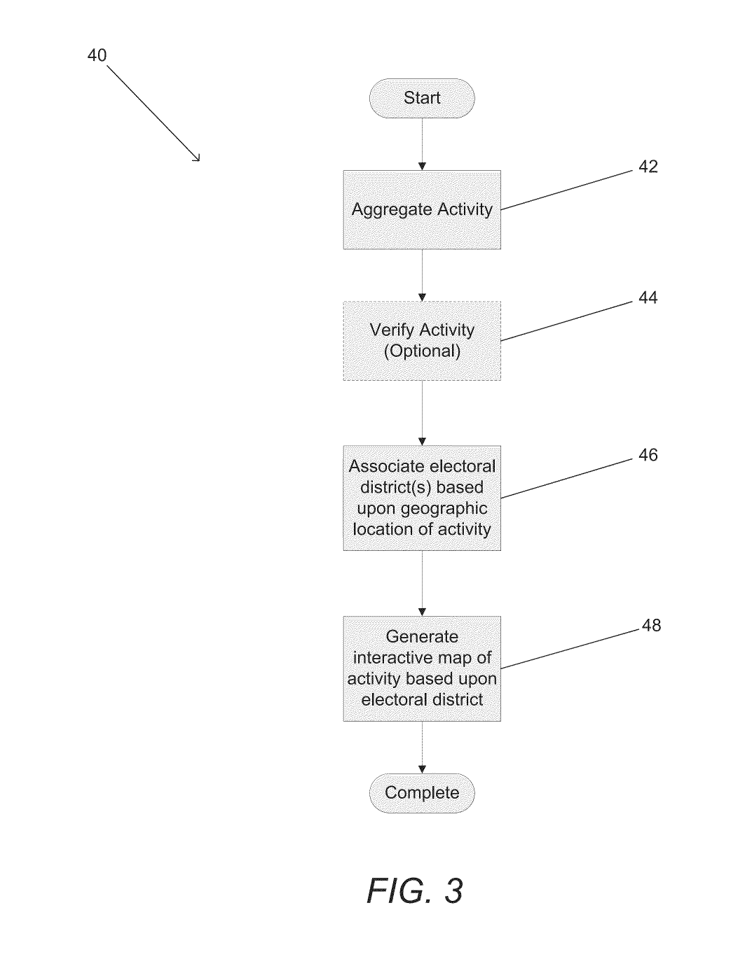

A process for aggregating online advocacy activity data based upon electoral district in accordance with an embodiment of the invention is illustrated in FIG. 3. The process 40 includes aggregating (42) online advocacy activity data using a system for aggregating online advocacy activities. In many embodiments, the online advocacy activity data is verified (44) to provide credibility when statistics and/or other information derived from the aggregated online advocacy activity data are presented to elected officials. Verification can involve verification that a residential address associated with online advocacy activity data is within an electoral district. Verification can further involve confirming that identifying information associated with the online advocacy activity data is associated with a registered voter having a residential address corresponding to the residential address associated with the online activity data (e.g. First Name, Last Name, phone number, and/or social security number). Verification can be performed by querying remote servers of a voter registration database service. In several embodiments, activity is only aggregated from sources that have been pre-verified through the creation of registered user accounts with an aggregation server system. In a number of embodiments, address information is provided as part of a process for registering for an activity, resource and/or service via a system for online aggregation of advocacy activity. The address can then be used for the purpose of mapping the advocacy activity of the constituent.

In the illustrated embodiment, one or more electoral district is associated (46) with each aggregated online advocacy activity based upon a geographic location associated with the activity. As is discussed above, a geographic location may be associated with a registered user account and/or a geographic location can be derived from a geographic location (geotag) associated with the online advocacy activity data (or social media activity data).

The aggregated online advocacy activity information and the associated electoral districts can then be utilized to generate (48) interactive maps. As is discussed further below, the interactive map can be entirely generated by the system using stored map data. Alternatively, the system can generate (48) an interactive map by generating a map layer that is provided to a remote server of a mapping service, which then generates a map incorporating the map layer. In many embodiments, interactive maps enable a user to drill down into statistics generated based upon the aggregated online advocacy activity information and displayed based upon electoral district. In a number of embodiments, a user can drill down to individual online advocacy activities to enable the user to link to the online advocacy activity and/or respond to the individual/voter that instigated the online advocacy activity. In several embodiments, privacy is a consideration. Therefore, processes and aggregation server systems in accordance with certain embodiments of the invention support various information access privileges. For example, administrators within an advocacy organization may be able to identify individual registered users that are conducting online advocacy activities by residential address. However, the residential addresses of registered users can be obfuscated during display of an interactive map to a user outside of the coordinating team such as (but not limited to) an elected official, a candidate for public office, and/or another advocacy organization. In many embodiments, elected officials may need to access the actual address information to verify addresses of individual constituents. In several embodiments, statistics concerning online advocacy activity conducted by voters within an electoral district are displayed using a heat map visualization (i.e. an area that increases in size based upon the volume of activity) centered on the elected official's offices and/or another appropriate visualization technique. In other embodiments, online advocacy information can be visualized relative to the geographic locations of real world organizing points (e.g. meeting locations, advocacy organizations) to encourage discussion of outreach and education at those places about the cause being advocated. Many advocacy organizations are reluctant to share information concerning the membership of the advocacy organization with people outside of the organization. Therefore, an aggregation server system that can enable multiple advocacy organizations to aggregate online advocacy activity data without sharing membership information can encourage greater coordination between advocacy organizations. Ultimately, the larger the number of constituents who care and the larger the amount of online advocacy activity that can be demonstrated to an elected official, the more likely the online advocacy activity will influence the policy position of the elected official.

Although specific processes for generating interactive maps using aggregations of online advocacy activity based upon electoral district are described above with reference to FIG. 3, any of a variety of processes can be utilized alone or in combination to generate an interactive map that enables user to explore the amount of online advocacy activity being undertaken by constituents within an electoral district in accordance with embodiments of the invention. Processes for aggregating online advocacy activity data from social media activity in accordance with embodiments of the invention are discussed further below.

### Processes for Aggregating Online Advocacy Activity from Social Media Services

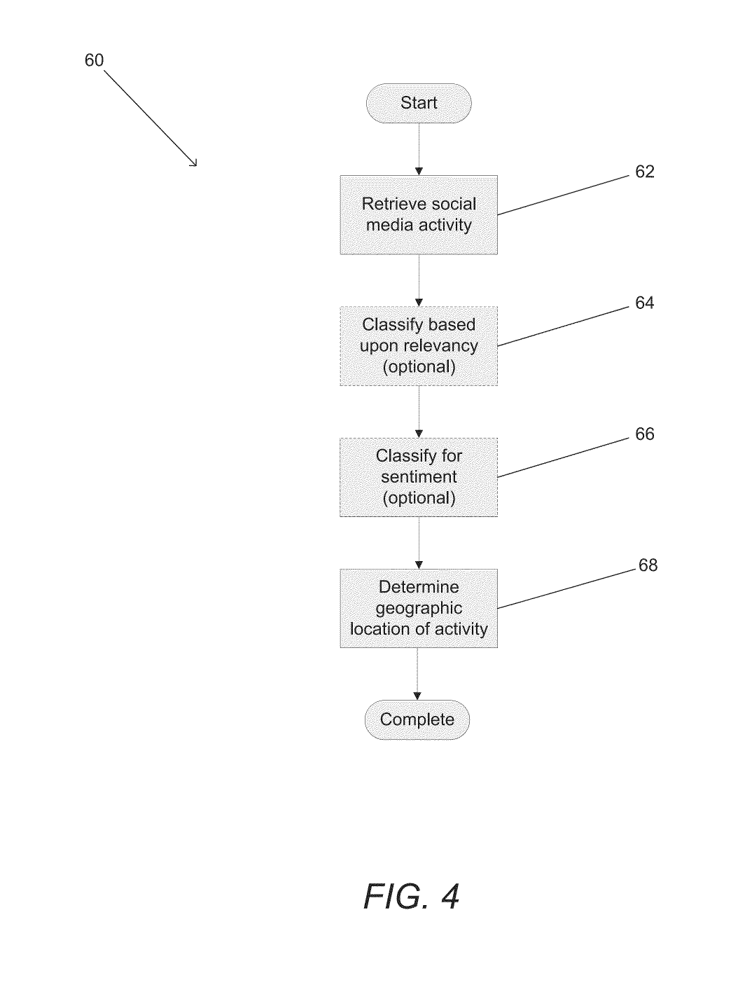

A process for generating online advocacy activity data from social media activity data retrieved from one or more social media services in accordance with an embodiment of the invention is illustrated in FIG. 4. The process 60 includes retrieving (62) social media activity data from one or more social media services. As discussed above, the social media activity data can be retrieved directly from the social media services via interfaces including (but not limited to) APIs published by the social media services and/or using services such as (but not limited to) the Radian6 service. Depending upon the manner in which the social media activity data is retrieved, the social media activity data may be pre-filtered for relevancy to online advocacy activities. In several embodiments, a classifier is optionally applied (64) to the retrieved social media activity data to score the data's relevancy to specific advocacy activities that are of interest. Furthermore, a classifier can be optionally applied (66) to score the sentiment of relevant online advocacy activities. Once social media activity data describing online advocacy activity is identified, a geographic location is determined (68) for the online advocacy activity. Many social media services publish geographic location information determined based upon a variety of factors including user profile information, IP address reverse lookup, and/or geotags provided by user devices used to conduct the social media activity. As discussed above, the geographic location information provided by the social media service can be utilized to identify one or more electoral districts. Where consistent with the terms of use of the API of a specific social media service, the geographic location information is recorded. Otherwise, the geographic location information is discarded and the electoral district(s) only are recorded. In many embodiments, the social media activity data is used to generate online advocacy activity data that is annotated by metadata describing attributes including (but not limited to) the time of the social media activity, the social media service utilized to conduct the social media activity, a URL enabling linking back to the social media activity on the social media service, the keywords and/or hashtags used to retrieve the social media data, and/or any relevancy, sentiment and/or other scores determined by classifiers applied to classify the social media activity data.

Although specific processes are described above with respect to FIG. 4 for aggregating online advocacy activity date from social media activity data retrieved from one or more social media services, any of a variety of techniques can be utilized to retrieve data from third party servers, analyze the data and aggregate the data in a database (along with metadata describing the source etc. of the data) as appropriate to the requirements of a specific application in accordance with embodiments of the invention.

### Processes for Generating Map Layers Showing Aggregated Online Advocacy Activity by Electoral District

The specific process utilized to generate a map layer typically depends upon the mapping service utilized to generate an interactive map. As noted above, several aggregation server systems in accordance with embodiments of the invention are implemented by adapting the Ushahidi platform to perform processes similar to those described herein. The Ushahidi platform uses OpenLayers to generate interactive maps. OpenLayers is open source software supported by the Open Source Geospatial Foundation that can be used to put a dynamic map in a web page. OpenLayers is a JavaScript library for displaying map data with no server-side dependencies. As such data used to generate an interactive map can be downloaded from an aggregation server system and the OpenLayers client can be used to provide interactive exploration of the map. A disadvantage of an architecture that relies upon the downloading of all of the mapping data is that data precisely describing the legally defined boundaries of the United States Congressional Districts based upon latitude and longitude coordinates can easily exceed 100 Mbytes of information, which is too great for rapid download and interactivity. Therefore, systems in accordance with many embodiments of the invention execute processes that simplify the description of the electoral districts published by governmental agencies (and used to associate electoral districts with aggregated online activity data) for the purpose of providing a small rapidly downloaded layer for an interactive map. In other embodiments, a remotely hosted mapping services such as (but not limited to) the Google Maps service provided by Google, Inc. of Mountain View, Calif. is utilized to generate interactive maps. Services such as the Google Maps service, store layers information in the cloud and generate image tiles in real time that are used to interactively render maps within a web browser. In this way, a user device need not download all of the mapping data in order to interactively explore the map. Accordingly, large and precise electoral map layers can be utilized on the server side to generate the image tiles provided to computing devices. For example, the Google Maps service provides a United States Congressional District map (goo.gl/QYJvE). In this way, an aggregation server system can utilize an API associated with the mapping service to upload layers describing relevant electoral districts using formats including (but not limited to) the Keyhole Markup Language (KML) file format. To render interactive maps, the aggregation server system can upload additional (smaller) map layers showing statistics and/or other information based upon aggregations of online advocacy activity data. As can readily be appreciated, the specific processes that are utilized to generate interactive maps that show information derived from aggregations of online advocacy activity data based upon electoral districts typically depend upon the requirements of a specific application including (but not limited to) the particular mapping service utilized to generate the interactive map.

### Sponsoring Projects as Online Advocacy Activity

In several embodiments, online advocacy activity can take the form of sponsorship and/or donations in support of specific projects. In a number of embodiments, a system for online aggregation of advocacy activities maintains records within an advocacy activity database describing a set of project portions that can be sponsored by a constituent. In many embodiments, an association is formed between the constituent's user profile and a specific project portion in the set of project portions and a user interface can be generated in which profile information from user profiles associates with specific project portions can be used to generate a graphical display of project support. In a number of embodiments, the project portions correspond to areas within a grid (e.g. a square meter of a building project). In several embodiments, profile information including (but not limited) to names, photos, and associated information such as messages can be displayed within a grid related to the user profile. In other embodiments, the project portions can be represented in any of a variety of ways and displayed in conjunction with any appropriate information as determined by the requirements of specific applications. In a number of embodiments, user actions including (but not limited to) sponsoring a project portion, generating a message, and/or sharing information concerning a project is aggregated as online advocacy activity within an advocacy activity database and presented via an online advocacy activity map in a manner similar to the various techniques for aggregating and presenting online advocacy activity data described above.

In a number of embodiments, mobile software applications installed on user devices can be utilized to solicit and/or receive user inputs indicative of the willingness to pledge funds in support of a cause. The mobile software applications can provide reports to a system for online aggregation of advocacy and the pledges are stored in advocacy activity database. In many instances, financial transaction information associated with specific user accounts is maintained in the advocacy activity database and the system for online aggregation of advocacy can initiate financial transactions based upon a predetermined criterion including (but not limited to) pledges exceeding a fundraising target, and a time period expiring. In several embodiments, the financial transactions are conducted via a financial transactions processing server maintained via a third party transaction processor.

Although the present invention has been described in certain specific aspects, many additional modifications and variations would be apparent to those skilled in the art. It is therefore to be understood that the present invention may be practiced otherwise than specifically described without departing from the scope and spirit of the present invention. Thus, embodiments of the present invention should be considered in all respects as illustrative and not restrictive.

What is claimed is:

1. A system for aggregating online advocacy activities, comprising:
an aggregation server system, comprising:
a processor; and
memory containing:
electoral district data, where the electoral district data describes the geographic boundaries of a plurality of electoral districts; and
an aggregation server application;
wherein the aggregation server application configures the processor to:
retrieve online advocacy activity data and store the online advocacy activity data within an advocacy activity database, where the online advocacy activity data describes a plurality of instances of advocacy activity;
associate at least one electoral district with the online advocacy activity data describing each of the plurality of instances of advocacy activity; and
generate an interactive map of advocacy activity occurring within the plurality of electoral districts.

2. The system of claim 1, wherein the aggregation server application configures the processor to retrieve online advocacy activity data from a remote server system that gathers reports of online advocacy activities.

3. The system of claim 2, wherein the remote server system is part of a social media service.

4. The system of claim 3, wherein the aggregation server application further configures the processor to:
retrieve data describing social media activities from the remote server system, which is part of a social media service; and
classify individual social media activities described in the retrieved data to identify online advocacy activities.

5. The system of claim 4, wherein the aggregation server application further configures the processor to score individual social media activities described in the retrieved online advocacy activity data and classified as online advocacy activities with respect to sentiment.

6. The system of claim 3, wherein the aggregation server application further configures the processor to:
retrieve data describing social media activities from the remote server system that is part of a social media service, where the retrieved data contains uniquely identifying information for at least one user of the social media service; and
retrieve data describing a residential address for each of the at least one user of the social media service identified by the uniquely identifying information from a remote server system that is part of a customer insight service.

7. The system of claim 2, wherein the online advocacy data is retrieved from the remote server system in batch form.

8. The system of claim 1, wherein the aggregation server application further configures the processor to receive reports containing online advocacy activity data over a network interface, where the reports are provided via a web interface.

9. The system of claim 1, wherein the aggregation server application further configures the processor to receive reports containing online advocacy activity data over a network interface, where the reports are provided via a user device configured with a mobile software application.

10. The system of claim 9, wherein the aggregation server system is connected to a network and the system further comprises:
a plurality of user devices, where each user device comprises:
a processor; and
memory containing a mobile software application;
wherein the mobile software application configures the processor to:
receive user input describing advocacy activity via a user interface;
generate a report containing online advocacy activity data describing the advocacy activity described in the user input; and
transmit the report to the aggregation server system.

11. The system of claim 10, wherein:
the mobile software application further configures the processor of a user device to:
receive a user input pledging to donate funds to a specific cause via a user interface; and
generate a report containing online advocacy activity data describing the pledge to donate funds to the specific cause; and
the aggregation server application further configures the processor to:
receive a report containing online advocacy activity data describing a pledge of a specific user to donate funds to a specific cause;
update a total pledged amount associated with the specific cause in the advocacy activity database; and
initiate at least one funds transfer based upon at lease one user pledge utilizing a transaction processing server system.

12. The system of claim 10, wherein the mobile software application further configures the processor of a user device to:
display user identifiers of a plurality of users of the system; and
initiate communication with at least one of the plurality of users of the system in response to a user instruction received via a user interface.

13. The system of claim 12, wherein the mobile software application further configures the processor of a user device to initiate communication using at least one communication technique selected from the group consisting of initiating a telephone call, initiating a video call, joining a conference call, sending a text message, and sending an electronic mail message.

14. The system of claim 1, wherein the aggregation server application further configures the processor to associate at least one electoral district with the online advocacy activity data describing each of the plurality of instances of advocacy activity by:
associating online advocacy activity data with at least one user account maintained within the advocacy activity database, where a residential address is associated with each of the at least one user account maintained within the advocacy activity database; and
mapping online advocacy activity data to at least one electoral district based upon a residential address of a user account with which the online advocacy activity data is associated.

15. The system of claim 1, wherein the aggregation server application further configures the processor to generate an interactive map of advocacy activity occurring within the plurality of electoral districts by querying the advocacy activity database to aggregate advocacy activity based upon individual electoral districts.

16. The system of claim 15, wherein the aggregation server application further configures the processor to generate an interactive map of advocacy activity occurring within the plurality of electoral districts by:
generating a layer of mapping data; and
providing the layer of mapping data to a remote server system of a mapping service.

17. The system of claim 1, wherein:
the aggregation server application further configures the processor to provide the interactive map to a user device; and
the interactive map enables the filtering of online advocacy activities based upon at least one of source of online advocacy activity data and type of advocacy activity using the user device.

18. The system of claim 1, wherein the aggregation server application further configures the processor to verify the online advocacy activity data by verifying that a residential address associated with the online advocacy activity data is located within an electoral district in which the advocacy activity occurred.

19. The system of claim 1, wherein the aggregation server application further configures the processor to verify the online advocacy activity data by verifying that a registered voter with identifying information corresponding to identifying information associated with the online advocacy activity data is registered to vote at a residential address associated with the online advocacy activity data.

20. The system of claim 1, wherein the aggregation server application configures the processor to generate the interactive map of advocacy activity occurring within the plurality of electoral districts containing information at a level of detail determined based upon access permissions of a user requesting the interactive map.

21. The system of claim 20, wherein the interactive map obfuscates residential addresses associated with online advocacy activity data associated with the residential addresses.

22. A system for aggregating online advocacy activities, comprising:
an aggregation server system, comprising:
a processor; and
a network interface;
memory containing:
electoral district data, where the electoral district data describes the geographic boundaries of a plurality of electoral districts; and
an aggregation server application;
wherein the aggregation server application configures the processor to:
retrieve online advocacy activity data and store the online advocacy activity data within an advocacy activity database, where the online advocacy activity data is contained in reports received via the network interface and describes a plurality of instances of advocacy activity; and
associate at least one electoral district with the online advocacy activity data describing each of the plurality of instances of advocacy activity by:
associating online advocacy activity data with at least one user account maintained within the advocacy activity database, where a residential address is associated with each of the at least one user account maintained within the advocacy activity database; and
mapping online advocacy activity data to at least one electoral district based upon a residential address of a user account with which the online advocacy activity data is associated; and
generating an interactive map of advocacy activity occurring within the plurality of electoral districts containing information at a level of detail determined based upon access permissions of a user requesting the interactive map by:
querying the advocacy activity database to aggregate advocacy activity based upon individual electoral districts;
generating a layer of mapping data filtered based upon the access permissions of the user requesting the interactive map; and
provide the layer of mapping data to a remote server system of a mapping service; and
a network;
a plurality of user devices, where each user device comprises:
a processor;
memory containing a mobile software application;
wherein the mobile software application configures the processor to:
receive user input describing advocacy activity via a user interface;
generate a report containing online advocacy activity data describing the advocacy activity described in the user input; and
transmit the report to the aggregation server system.
